(19) United States
(12) Patent Application Publication
(10) Pub. No.: US 2009/0301514 A1
(43) Pub. Date: Dec. 10, 2009

(54) Dental floss dispenser

(76) Inventor: Benito Passafaro, Schoftland (CH)

Correspondence Address: PATENTANWAELTE LICHTI + PARTNER GBR, POSTFACH 41 07 60, D-76207, KARLSRUHE, DE

(21) Appl. No.: 12/292,423

(22) Filed: Nov. 19, 2008

(30) Foreign Application Priority Data
Jun. 6, 2008 (CH) 135 212
Oct. 30, 2008 (DE) 202008014429.9

(51) Int. Cl. A61C 15/04

(52) U.S. Cl. 132/326

(57) ABSTRACT

A dental floss dispenser has a case accommodating a thread of dental floss which emerges from the case through an outlet so that its end is accessible from the exterior of the case. The dental floss dispenser has a holding device, by means of which at least a section of the end of the thread of dental floss is held in defined alignment. The case is thereby structured to simplify transfer of a section of dental floss to a grasping and holding member.

This application claims Paris Convention priority of DE 20 2008 014 429.9 filed Oct. 30, 2008 and CH 1 35 212 filed Jun. 6, 2008 the complete disclosures of which are hereby incorporated by reference.

### BACKGROUND OF THE INVENTION

The invention concerns a dental floss dispenser with a case accommodating a thread of dental floss which emerges from the case through an outlet so that its end is accessible from the exterior of the case.

Known interdental cleaning practices include using a section of a so-called thread of dental floss, which is commonly made of plastic. A section of the desired length is severed from the thread of dental floss, both ends are held by the user, inserted into an interdental space and moved back and forth at that location. Using this technique, however, makes it relatively difficult to hold the section of dental floss steady, which becomes even more difficult as the user's fingers are moistened with saliva while using the thread of dental floss. Furthermore, this procedure is unesthetic and doubtful from the point of view of hygiene, as the user must introduce at least several fingers into the mouth.

A holder for a section of dental floss is known from CH 695 439 A5. The holder consists of a Y-shaped main part with a handle to which an equally Y-shaped clamping part is attached on a swiveling bearing. The main and clamping parts together form two pliers-like grippers which can be opened or closed by swiveling the clamping part. When a section of dental floss is inserted into the two pliers-like grippers and the grippers are then closed, the section of dental floss is clamped tightly between the two pliers-like grippers. Accordingly, in order to clean between the teeth, the user must merely insert the holder with the clamped section into the mouth and clean the interdental spaces in the conventional manner. While doing so, the user's fingers can remain outside of the oral cavity, which is desirable from the point of view of hygiene. Furthermore, the user's saliva does not interfere with holding the section of dental floss, as that section remains clamped tight between the pliers-like grippers.

However, the holder in accordance with CH 695 439 A5 has the disadvantage that it is relatively difficult to insert the section of dental floss into the pliers-like grippers. To do so, the user must sever a section of desired length from the thread of dental floss and then insert that section manually into the pliers-like grippers and subsequently close the grippers. This involves the risk of the section of dental floss not being properly clamped in the pliers-like grippers and in particular not being held under sufficient tension between the grippers.

The invention is based on the task of creating a dental floss dispenser that makes it easier to transfer a section of dental floss to a holder, in particular one of the above-mentioned kind.

### SUMMARY OF THE INVENTION

According to the invention, this task is fulfilled by a dental floss dispenser with the features recited in the independent claim. The dental floss dispenser is provided with a holding device, by means of which at least a section of the end of the thread of dental floss is held in defined alignment.

According to the invention, the basic consideration is that the section of dental floss to be transferred to the holder is already held in defined alignment at the dental floss dispenser so that the user can pick up the section of dental floss directly from the dental floss dispenser. In this way, it is possible for the user to completely avoid taking the holder into his hands when clamping the thread of dental floss, which is favorable for reasons of hygiene.

In a preferred embodiment of the invention, the end of the thread of dental floss is provided to run in a straight line between the outlet through which the thread of dental floss emerges from the interior of the case and the holding device so that this straight section of dental floss can be picked up immediately from the holder. This end of the thread of dental floss is preferably held at least under low tension between the outlet and the holding device, which ensures that the thread of dental floss is easily transferred to the holder.

The tension of the end of the thread of dental floss can be ensured through the pull-out resistance to which the thread is subjected when being pulled out of the case at the outlet. This pull-out resistance depends mainly on fictional forces. As the thread of dental floss is usually wound on a spool within the case and is unwound from that spool when being pulled out, additional frictional forces come into play which hold the section of dental floss outside of the case under low tension.

In a preferred embodiment of the invention, both the outlet and the holding device are located on the upper side of the case, so that the end of the thread of dental floss which is outside the case runs along the upper side of the case when aligned as intended. In order to be able to use the holder to pick up the end of the thread of dental floss in an easy manner, a further development of the invention provides that at least one guiding channel is located immediately below the end of the thread of dental floss, into which the holder can be inserted to pick up the thread of dental floss and which is bridged by the end of the thread of dental floss. In order to pick up the end of the thread of dental floss, the user takes the holder, opens the pliers-like grippers of the holder and inserts the grippers in open position into the guiding channel until the grippers are located at the level of the end of the thread of dental floss or until that end is located between the opened pliers-like grippers. The user then closes the pliers-like grippers of the holder, thus clamping the end of the thread securely in the holder. Afterwards, the user can remove the holder from the guiding channel, preferably upwardly, while simultaneously pulling another section of dental floss out of the case. After severing the end clamped in the holder from the following section, for example by cutting or tearing it off, the holder carrying the clamped end of the thread of dental floss is ready for use.

If a holder with two parallel spaced pliers-like grippers is used, as is described in CH 695 439 A5, two guiding channels aligned parallel to each other should be provided. When inserting the holder, one pliers-like gripper is inserted into each guiding channel with tight fit, ensuring defined relative motion between the holder and the dental floss dispenser. Furthermore, this indicates how to insert the holder to the user in a simple manner.

In order to protect the end of the thread of dental floss outside the case from impurity when the dental floss dispenser is not used, a lid or flap should be provided in a preferred embodiment of the invention, by means of which the end of the thread of dental floss, and preferably also the outlet and the holding device, can be covered. The lid can be provided as a separate component and placed, and preferably locked, onto the case; in a preferred embodiment of the invention, however, the lid is provided to be hinged to and in particular integrally formed at the case, which can be achieved, for example, through a plastic hinge joint.

After the end of the thread of dental floss has been picked up and clamped using the holder, the end of the thread of dental floss must be severed from the following thread of dental floss. In a preferred embodiment of the invention, a cutting device fitted to the dental floss dispenser is provided towards that end, which can be used to cut the thread of dental floss in two. In a preferred embodiment of the invention, the cutting device is provided to be integrated in the holding device. This can be achieved in a simple manner if the holding device consists of a clamping lug preferably made of metal, i.e., a part of a metal plate protruding at a slant angle and attached at the base, under which the thread of dental floss can be clamped. In this case, the cutting device can consist of an edge of the clamping lug.

Further details and features of the invention will be more readily understood by reference to the following description of an embodiment and the drawing, wherein:

### BRIEF DESCRIPTION OF THE DRAWING

FIG. 1 shows a dental floss dispenser with an open lid according to the invention,

FIG. 2 shows the dental floss dispenser as illustrated in FIG. 1 with a closed lid,

FIG. 3 shows a perspective view of an open holder to be used together with the dental floss dispenser according to the invention,

FIG. 4 shows a perspective bottom view of the holder as illustrated in FIG. 3,

FIG. 5 shows the holder and the dental floss dispenser before the thread of dental floss is picked up,

FIG. 6 shows the holder and the dental floss dispenser while the thread of dental floss is being picked up,

FIG. 7 shows the holder and the dental floss dispenser while the thread of dental floss is being clamped,

FIG. 8 shows the holder and the dental floss dispenser while the thread of dental floss is being severed, and

FIG. 9 shows the holder with the clamped end of the thread of dental floss.

### DESCRIPTION OF THE PREFERRED EMBODIMENT

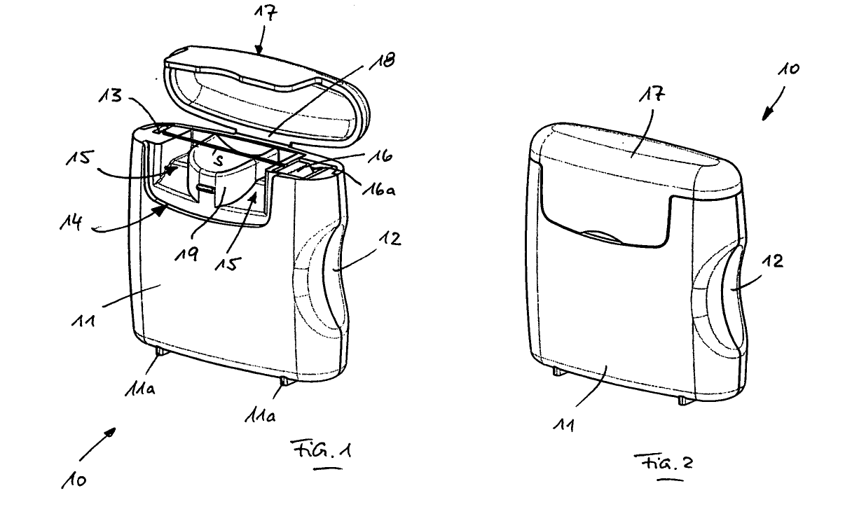

FIG. 1 shows a dental floss dispenser 10 with a box-type case 11 with feet 11a on its bottom side, with the help of which the dental floss dispenser 10 can be placed on a surface. In the embodiment shown here, one side of the case 11 has a gripping recess 12 in order to make it easier for the user to take hold of the dental floss dispenser 10 and hold it steady.

The interior of the case 11 accommodates a supply of thread of dental floss S in a way not shown here, which is usually wound up on a spool and can be pulled from same. The thread of dental floss S emerges from the interior of the case 11 through an outlet 13, which is provided on the upper side of the case 11, so that an end of the thread of dental floss S can be accessed by a user from the exterior of the case 11.

As FIG. 1 shows, the outlet 13 is provided on the edge of the upper side of the case 11. On the opposite edge of the case 11, a holding device 16 is provided, which consists of a clamping lug made, for example, of metal, under which the thread of dental floss S can be clamped. The lateral edge of the clamping lug, which is located opposite to the outlet 13, serves as a cutter 16a for the thread of dental floss S.

As FIG. 1 shows, the thread of dental floss S extends in straight alignment from the outlet 13 to the holding device 16. The free end of the thread of dental floss S is clamped under the holding device 16. Due to the frictional forces occurring within the case 11 and also at the outlet 13, the thread of dental floss S is held under low tension between the outlet 13 and the holding device 16 and is thus aligned straight.

Immediately below the end of the thread of dental floss S, which is located on the upper side of the case 11, a guiding device is provided, which consists of two parallel guiding channels 15, which are separated by a central blocking part 19. The guiding channels 15 serve to insert the pliers-like grippers of a holder 20 (see FIG. 3) in order to pick up the exposed end of a thread of dental floss, as will be described in detail below.

A lid 17 is formed at the lateral edge of the case 11, which is located opposite to the guiding channels 14, via a hinge joint 18. The lid 17 can be swiveled from the open position shown in FIG. 1 to the closed position shown in FIG. 2, where it completely covers the upper side of the case 11 including the outlet 13, the holding device 16, and the exposed end of the thread of dental floss S. In its closed position, the lid 17 is appropriately locked with the case 11.

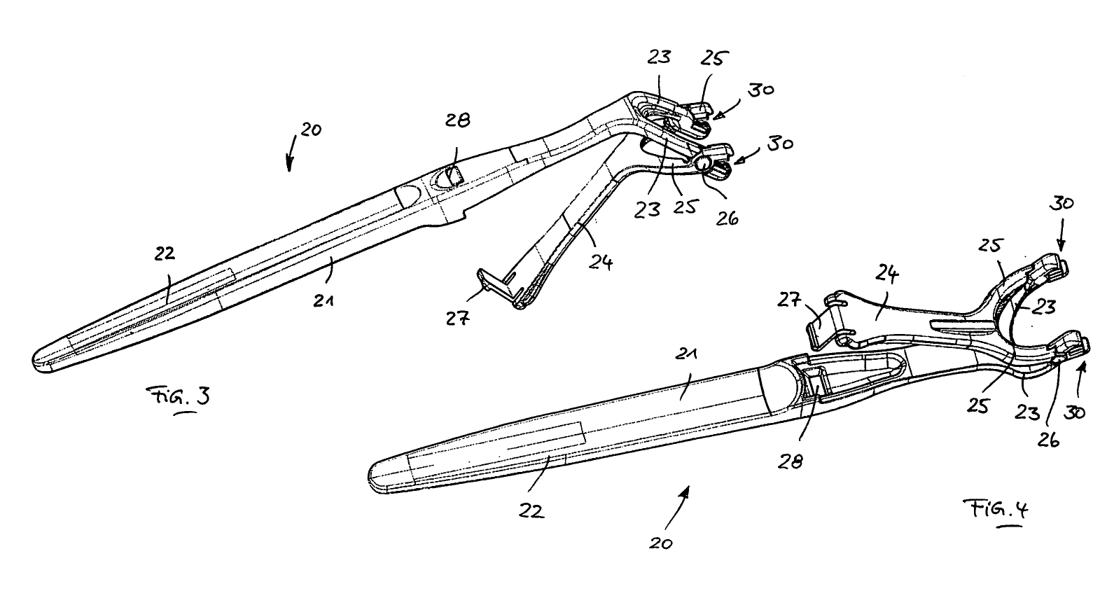

FIGS. 3 and 4 show a holder designed to pick up the exposed end of the thread of dental floss S from the dental floss dispenser 10. The holder 20 has a main part 21, whose rear end forms a handle 22 and whose front end is Y-shaped and has two essentially parallel spaced arms 23. A clamping part 24 has similar arms 25 at its front end, each of which is connected to the arms 23 of the main part 21 via a swivel joint 21. In this way, two pliers-like grippers 30 are formed at the front end of the holder 20, which can be opened or closed as desired by swiveling the clamping part 24 relative to the main part 21.

The rear end of the clamping part 24, which is located opposite to the arms 25, is fitted with a locking lug 27, which locks with a recess 28 of the basic part 28 when the clamping part 24 has been swiveled relative to the main part 21 in order to close the grippers 30. This locks the grippers 30 in the closed position and they can only be re-opened by unlocking the locking lug 27 at the recess 28.

FIGS. 5 through 9 show the picking-up of the exposed end of the thread of dental floss S from the dental floss dispenser 10 by means of the holder 20, broken down in separate phases.

According to FIG. 5, the end of the thread of dental floss S is located on the upper side of the case 11 of the dental floss dispenser 10 in straight alignment between the holder 16 and the outlet 13 and bridges the guiding channels 15, which are open upwardly. The lid 17 is open, so that the user has free access to the thread of dental floss S. The user takes the holder 20 and inserts each of its pliers-like grippers 30, which are in open position, into one of the guiding channels 15 of the guiding device 14 as indicated by the arrow P1 in FIG. 5.

While inserting the pliers-like grippers 30 into the guiding channels 15, the open end of the thread of dental floss will inevitably be positioned between the open grippers 30 as shown in FIG. 6. In this situation, while reaching inside the guiding channels 15, the user swivels the clamping part 24 of the holder 20 (see arrow P2) until the locking lug 27 of the clamping part 24 locks with the locking recess 28 of the main part 21 of the holder 20. The pliers-like grippers 30 are thus closed and each of them clamps a different area of the exposed end of the thread of dental floss S between them.

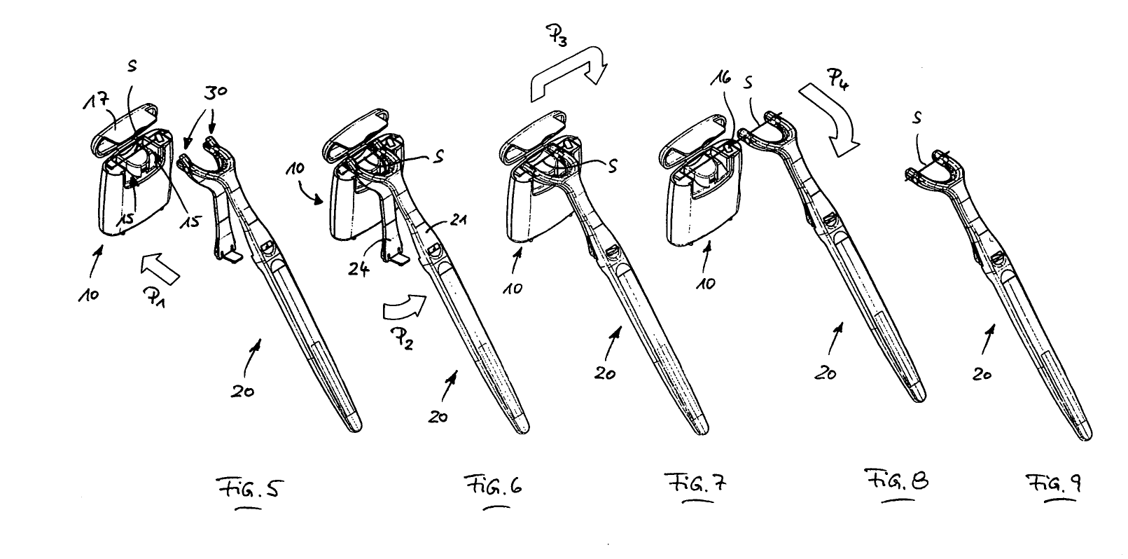

The user then lifts the holder 20 upwards out of the guiding channels 14 (see arrow P3 in FIG. 7) while simultaneously pulling another section of dental floss S out of the outlet 13. As FIG. 8 shows, the user pulls the thread of dental floss S out until the holder 20 is entirely located next to the dental floss dispenser 10. The thread of dental floss S is passed through the clamping lug which forms the holding device 16 in the area outside the pliers-like grippers 30 and is clamped there and simultaneously severed by the lateral edge of the clamping lug. Arrow P4 in FIG. 8 indicates this movement. As FIG. 9 shows, the user then holds the holder 20 in his hand with closed grippers 30 and a section of dental floss clamped between them, so that he can start cleaning between the teeth. After cutting the thread of dental floss S in two, the dental floss dispenser reassumes exactly the same configuration that it had when the picking-up of the exposed end of the thread of dental floss S began.

I claim:

1. A dental floss dispenser within which dental floss thread is disposed for dispensing thereof, the dispenser comprising:
a case, said case structured and dimensioned to accommodate the dental floss thread, said case having an outlet through which the dental floss thread emerges from said case such that an end of the dental floss thread is accessible from an exterior of said case; and
a holding device cooperating with said case to hold at least an end section of the dental floss thread in defined alignment thereof.

2. The dental floss dispenser of claim 1, wherein the end section of the dental floss thread extends in a straight line between said outlet and said holding device.

3. The dental floss dispenser of claim 1, wherein the end section of the dental floss thread is held under tension between said outlet and said holding device.

4. The dental floss dispenser of claim 1, wherein said case defines at least one guiding channel disposed below the end section of the dental floss thread, said guiding channel being disposed, structured and dimensioned to accept insertion of a holder to grasp the dental floss thread.

5. The dental floss dispenser of claim 4, wherein said case defines two parallel guiding channels.

6. The dental floss dispenser of claim 1, further comprising a lid by means of which the end section of the dental floss thread, said outlet, and said holding device can be covered.

7. The dental floss dispenser of claim 6, wherein said lid is formed at said case by means of a joint.

8. The dental floss dispenser of claim 1, further comprising a cutting device to cut through an end of the dental floss thread.

9. The dental floss dispenser of claim 8, wherein said cutting device is integrated in said holding device.

10. The dental floss dispenser of claim 1, wherein said holding device is a clamping lug.

11. The dental floss dispenser of claim 8, wherein said holding device is a clamping lug and said cutting device is fashioned by an edge of said clamping lug.
